(19) United States
(12) Patent Application Publication
(10) Pub. No.: US 2023/0092564 A1
(43) Pub. Date: Mar. 23, 2023

(54) MODEL UPDATE DETERMINATION

(71) Applicant: INTERNATIONAL BUSINESS MACHINES CORPORATION, Armonk, NY (US)

(72) Inventors: XIAO MING MA, XIAN (CN); SI ER HAN, XIAN (CN); XUE YING ZHANG, XIAN (CN); JING XU, XIAN (CN); JI HUI YANG, BEIJING (CN)

(21) Appl. No.: 17/477,194

(22) Filed: Sep. 16, 2021

(51) Int. Cl. G06K 9/62; G06N 20/00

(52) U.S. Cl. CPC G06K 9/6218; G06K 9/6256; G06N 20/00

(57) ABSTRACT

According to embodiments, a method, a device and a computer program product for model update determination are proposed. In the method, a plurality of historical data items and a plurality of new data items are obtained. The plurality of historical data items were used for training a model, and the plurality of new data items are to be applied to the model. At least one of an overall difference, a structural difference, and a confidence difference between the plurality of historical data items and the plurality of new data items is determined. Thereby, an indication indicating whether to update the model is determined based on the at least one of the overall difference, the structural difference, and the confidence difference.

### BACKGROUND

The present disclosure relates to model management, and more specifically, to a method, system and computer program product for model update determination.

With the development of information technology, various models have been used increasingly, such as causal models, machine learning models, neural network models, data analysis models, linear models, nonlinear models, etc. These models help users to solve various problems.

### SUMMARY

According to an embodiment, there is provided a computer-implemented method. According to the method, a plurality of historical data items and a plurality of new data items are obtained. The plurality of historical data items were used for training a model, and the plurality of new data items are to be applied to the model. At least one of an overall difference, a structural difference, and a confidence difference between the plurality of historical data items and the plurality of new data items is determined. Thereby, an indication indicating whether to update the model is determined based on the at least one of the overall difference, the structural difference, and the confidence difference.

According to an embodiment, there is provided a system. The system comprises a processing unit and a memory coupled to the processing unit and storing instructions thereon. The instructions, when executed by the processing unit, perform acts including: obtaining a plurality of historical data items and a plurality of new data items, the plurality of historical data items being used for training a model, and the plurality of new data items being to be applied to the model; determining at least one of an overall difference, a structural difference, and a confidence difference between the plurality of historical data items and the plurality of new data items; and determining, based on the at least one of the overall difference, the structural difference, and the confidence difference, an indication indicating whether to update the model.

According to an embodiment, there is provided a computer program product comprising a computer-readable storage medium having program instructions embodied therewith. The program instructions are executable by a processor to cause the processor to perform acts of: obtaining a plurality of historical data items and a plurality of new data items, the plurality of historical data items being used for training a model, and the plurality of new data items being to be applied to the model; determining at least one of an overall difference, a structural difference, and a confidence difference between the plurality of historical data items and the plurality of new data items; and determining, based on the at least one of the overall difference, the structural difference, and the confidence difference, an indication indicating whether to update the model.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment.

FIG. 2 depicts a cloud computing environment according to an embodiment.

FIG. 3 depicts abstraction model layers according to an embodiment.

FIG. 4 depicts a flowchart of an example of a method for model management according to an embodiment.

FIG. 5 depicts a schematic diagram of an example of historical data items according to an embodiment.

FIG. 6 depicts a schematic diagram of an example of new data items according to an embodiment.

FIG. 7 depicts a schematic diagram of an example of historical data items clustering according to an embodiment.

FIG. 8 depicts a schematic diagram of an example of new data items clustering according to an embodiment.

FIG. 9 depicts a schematic diagram of an example of target value distributions according to an embodiment.

FIG. 10 depicts a schematic diagram of an example of a confidence interval according to an embodiment.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, the present embodiments are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

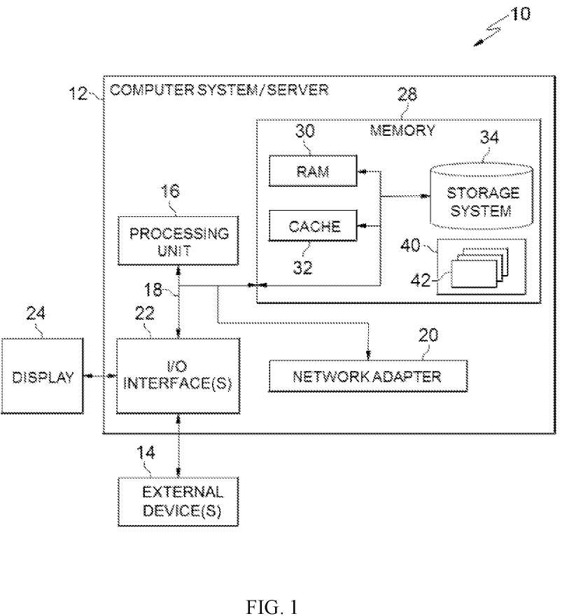

Referring now to FIG. 1, a schematic of an example of a cloud computing node is shown. Cloud computing node 10 is only one example of a suitable cloud computing node and is not intended to suggest any limitation as to the scope of use or functionality of the embodiments described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors 16 (or processing units), a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of the present embodiments.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of the embodiments described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

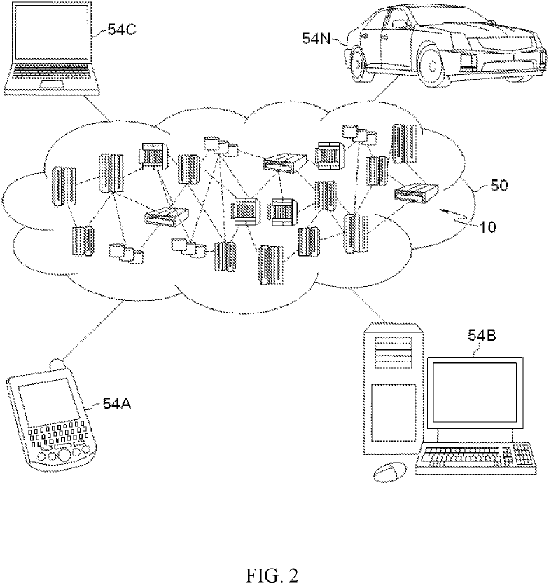

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

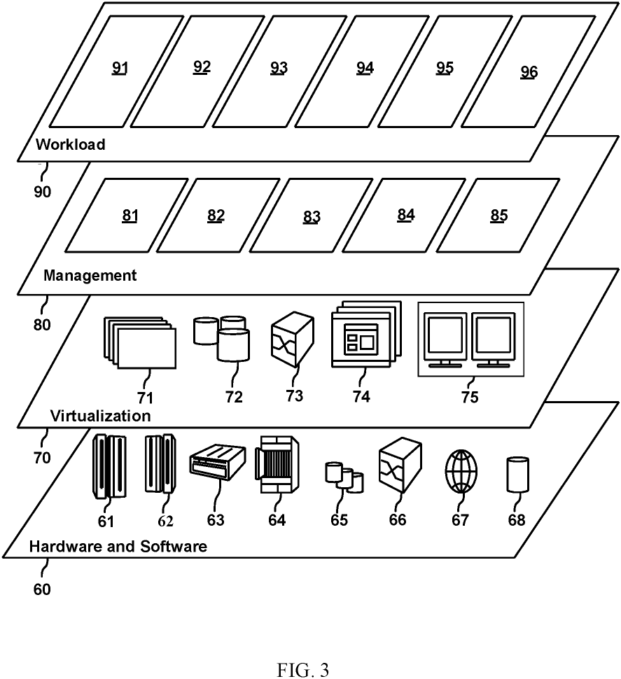

Referring now to FIG. 3, a set of functional abstraction layers provided by cloud computing environment 50 (FIG. 2) is shown. It should be understood in advance that the components, layers, and functions shown in FIG. 3 are intended to be illustrative only and the embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and model management 96.

In certain examples, a model may perform well at the initial stage when the model was built with historical data items. However, the model may degrade over time as new data items become more and more. In this case, it may be desirable to determine whether to update the model. However, the traditional model update determination may be inefficient and inaccurate.

Traditionally, if target values for new data items are accessible, the target values can be used to determine the performance of the original model. However, the target values may be difficult to obtain, and only predicting values for the new data items are accessible.

As the target values may be inaccessible, various techniques are proposed to determine whether to update the original model. For example, one traditional approach compares the variable distribution between the new data items and the historical data items separately. For a categorical variable, the chi-square test is used to check the categorical value distribution between the new data items and the historical data items. In addition, for a continuous variable, the value range of the continuous variable is divided into many intervals, and then the chi-square test is used to check the values in each interval between the new data items and the historical data items. Then, all variables chi-square test results are averaged as the final result. However, such a traditional approach fails to consider the combination of various factors, and may be inefficient and/or inaccurate.

An improved solution for model management is provided in the present embodiments. Generally speaking, according to embodiments of the present disclosure, a plurality of historical data items and a plurality of new data items are obtained. The plurality of historical data items were used for training a model, and the plurality of new data items are to be applied to the model. At least one of an overall difference, a structural difference, and a confidence difference between the plurality of historical data items and the plurality of new data items are determined. Thereby, an indication as to whether to update the model is determined based on the at least one of the overall difference, the structural difference, and the confidence difference.

In accordance with the model management as proposed herein, the overall difference, the structural difference, and/or the confidence difference between the plurality of historical data items and the plurality of new data items can be used in combination to achieve efficient and accurate model update determination.

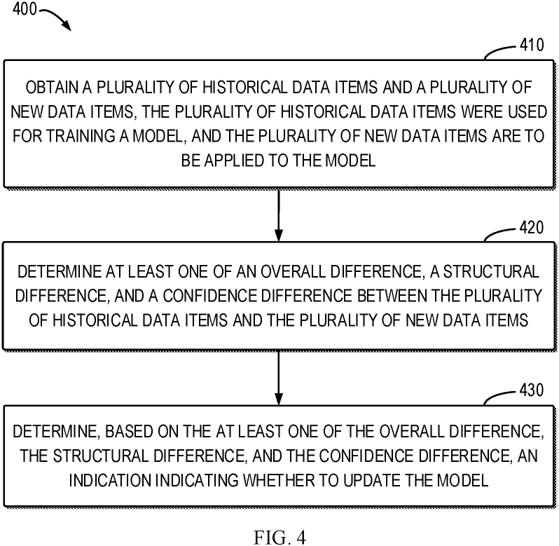

Now some example embodiments will be described with reference to FIGS. 4-8. FIG. 4 depicts a flowchart of an example of a method for model management 400 according to an embodiment. The method for model management 400 may be at least in part implemented by the computer system/server 12, or other suitable systems.

At operation 410, the computer system/server 12 obtains a plurality of historical data items and a plurality of new data items. The plurality of historical data items were used for training a model, and the plurality of new data items are to be applied to the model.

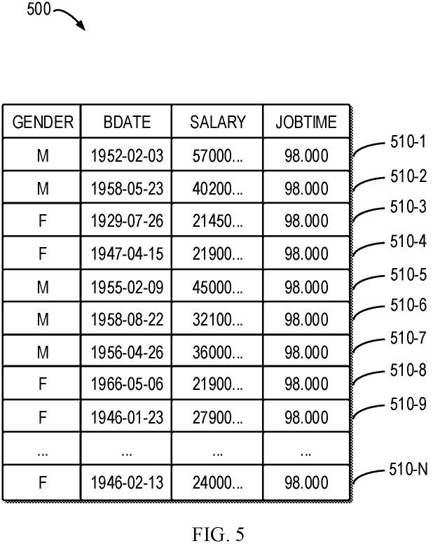

FIG. 5 depicts a schematic diagram 500 of an example of historical data items according to an embodiment. FIG. 5 shows a plurality of historical data items 510-1 to 510-N (collectively referred to as “historical data items 510” hereinafter, in which N is an integer greater than 1). Each of the historical data items 510 may include at least one field, such as gender, date of birth, salary and job time. It should be appreciated that the historical data items 510 may contain other fields that the ones shown in FIG. 5.

The historical data items 510 were used for training or creating a model for resolving various problems and performing various analyses. The model can be any appropriate model, such as a causal model, a machine learning model, a neural network model, a data analysis model, a linear model, a nonlinear model, or the like.

As described above, the model performs well at the initial stage when the model was trained or built with the historical data items 510. However, because the new data items may be varied from the historical data items 510, the model will degrade over time as new data items are added.

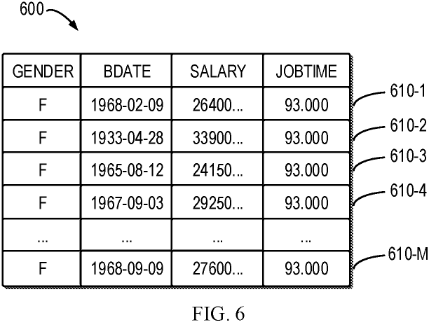

FIG. 6 depicts a schematic diagram 600 of an example of new data items according to an embodiment. FIG. 6 shows a plurality of new data items 610-1 to 610-M (collectively referred to as “new data items 610” hereinafter, in which M is an integer greater than 1). Similar to the historical data items 510, each of the new data items 610 may include at least one field, such as gender, date of birth, salary and job time.

It should be understood that, although the fields contained in the new data items 610 are shown as the same as the fields contained in the historical data items 510, the fields of the new data items 610 and the historical data items 510 may be different. In addition, the new data items 610 and the historical data items 510 are only examples, the content of these data items can be any appropriate content.

Referring back to FIG. 4, at operation 420, the computer system/server 12 determines at least one of an overall difference, a structural difference, and a confidence difference between the plurality of historical data items 510 and the plurality of new data items 610. Thereby, at operation 430, the computer system/server 12 determines, based on the at least one of the overall difference, the structural difference, and the confidence difference, an indication of whether to update the model.

For example, the computer system/server 12 may obtain respective weights for the overall difference, the structural difference, and the confidence difference. In some embodiments, the weights can be first set by the user, and learned with the model update process.

Then, the computer system/server 12 may weight the overall difference, the structural difference, and the confidence difference by their respective weights, and the sum of the weighted differences can be used to determine the indication indicating whether to update the model. For example, the computer system/server 12 may compare the sum with a predetermined threshold. If the sum is greater than the predetermined threshold, which means the differences between the new data items 610 and the historical data items 510 are significant, the indication may indicate to update the model.

By considering the overall difference, the structural difference, and/or the confidence difference between the historical data items 510 and the new data items 610, efficient and accurate model update determination can be achieved.

The following text will describe in detail how to determine the overall difference, the structural difference, and the confidence difference, respectively.

The overall difference is associated with a proportion of new data items 610 that are dissimilar to the historical data items 510 for all the new data items 610. In some embodiments, in order to determine the overall difference, the computer system/server 12 may cluster the plurality of historical data items 510 into a plurality of clusters (referred to as “a first plurality of clusters” hereinafter). In this case, similar historical data items 510 may be clustered into the same cluster. In some embodiments, the historical data items 510 can be clustered using any appropriate clustering techniques, such as DBSCAN (Density-Based Spatial Clustering of Applications with Noise), K-Means clustering, or the like.

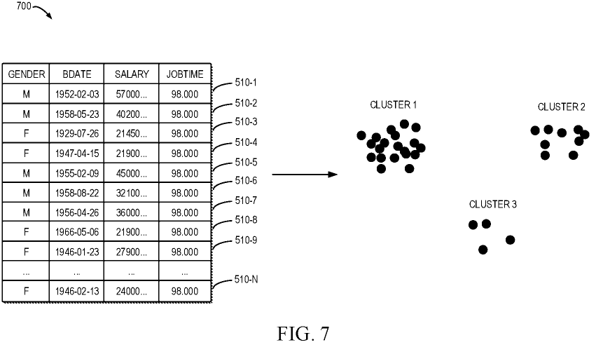

FIG. 7 depicts a schematic diagram 700 of an example of historical data items clustering according to an embodiment. As shown in FIG. 7, the historical data items 510 are clustered into three clusters, that is clusters 1-3.

In addition, in some embodiments, the computer system/server 12 may also cluster the plurality of new data items 610 into a plurality of clusters (referred to as “a second plurality of clusters” hereinafter). In this case, similar new data items 610 may be clustered into the same cluster. Just like the historical data items 510, the new data items 610 may be clustered using any appropriate clustering techniques.

In some embodiments, the new data items 610 and the historical data items 510 may be clustered using the same clustering technique. For example, both the new data items 610 and the historical data items 510 may be clustered using DBSCAN. In this case, the new data items and the historical data items clustered into the same cluster can be treated as similar data items. For instance, it is assumed that the historical data items 510-2, 510-5 and 510-9 are clustered into the cluster 3, and the new data items 610-2 is also clustered into the cluster 3. In this case, the historical data items 510-2, 510-5 and 510-9 and the new data items 610-2 can be treated as similar data items.

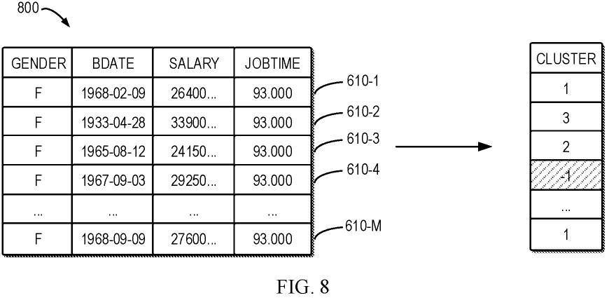

FIG. 8 depicts a schematic diagram 800 of an example of new data items clustering according to an embodiment. As shown in FIG. 8, the new data items 610 are clustered into four clusters. Specifically, the new data item 610-1 is clustered into the cluster 1, the new data item 610-2 is clustered into the cluster 3, the new data item 610-3 is clustered into the cluster 2, the new data item 610-4 is clustered into the cluster -1, and the new data item 610-M is clustered into the cluster 1.

Regarding the cluster -1, as described above, the new data items 610 may be varied from the historical data items 510. In this case, some new data items may be clustered into a different cluster than the clusters of the historical data items 510. Such different cluster may be denoted as cluster -1, to indicate that the new data item 610-4 is an outlier new data item which is not similar to any of the historical data items 510.

In addition, as described above, the overall difference is associated with a proportion of new data items dissimilar to the historical data items 510 in all the new data items 610. In this case, to determine the overall difference, the computer system/server 12 may determine the first number of data items in the plurality of new data items 610, that is to say, the total number of all the new data items in the plurality of the new data items 610.

In addition, the computer system/server 12 may also select outlier new data items in the plurality of new data items. The clusters of the outlier new data items are different from the first plurality of clusters. For example, the new data item 610-4 is the outlier new data item, and the cluster -1 of the new data item 610-4 is different from the clusters 1-3. To this end, the computer system/server 12 may select a first set of new data items from the plurality of new data items. A cluster of each data item in the first set of new data items according to the second plurality of clusters is different from the first plurality of clusters. In this case, the computer system/server 12 may determine the second number of data items in the first set of data items, that is to say, the total number of all the data items in the first set of data items.

Thereby, the computer system/server 12 may determine, based on the first number and the second number, the overall difference. For example, the overall difference may be the quotient derived by dividing the second number with the first number. In this case, more outlier new data items will result in higher overall difference, which means that the new data items 610 are more different from the historical data items 510.

The determination of the overall difference has been described above, and the following text will further describe the structural difference.

The structural difference is associated with the difference between the structures of the new data items 610 and the historical data items 510. Specifically, the structural difference is associated with a proportion of new data items having a structure dissimilar to the historical data items 510 in all the new data items 610. In some embodiments, in order to determine the structural difference, the computer system/server 12 may select, from all the new data items 610, a set of new data items similar to the historical data items 510. In this case, the outlier new data items will be excluded from the selection.

Specifically, the computer system/server 12 may select a second set of new data items from the plurality of new data items. A cluster of each data item in the second set of new data items according to the second plurality of clusters is the same as a cluster of the first plurality of clusters. For example, the new data items 610-1, 610-2, 610-3 and 610-M can be selected into the second set of the new data items, because their clusters belong to the clusters 1-3 of the historical data items 610.

Then, the computer system/server 12 may select a third set of new data items from the second set of new data items. A structure of each data item in the third set of new data items is different from structures of the plurality of historical data items. In this case, the computer system/server 12 may designate the third number of data items in the third set of new data items, that is to say, the total number of all the data items in the third set of new data items.

As described above, the structural difference is associated with a proportion of new data items having a structure dissimilar to the historical data items 510 in all the new data items 610. In this case, the computer system/server 12 may determine the structural difference based on the first number of data items in the plurality of new data items and the third number. For example, the structural difference may be the quotient derived by dividing the third number with the first number. In this case, more new data items having structures different from the structures of the historical data item 510 will result in a higher structural difference, which also means that the new data items 610 are more different from the historical data items 510.

In some embodiments, in order to select the third set of new data items, the computer system/server 12 may perform the following process for each data item of the second set of new data items. For example, the computer system/server 12 may select historical data items of the same cluster as the new data item. Specifically, the computer system/server 12 may determine a cluster of the new data item. In addition, the computer system/server 12 may select a first set of historical data items from the plurality of historical data items 510. The first set of historical data items have been clustered into the same cluster as the new data item.

For example, it is assumed that the new data item 610-2 and the historical data items 510-2, 510-5 and 510-9 are clustered into the cluster 3. In this case, the historical data items 510-2, 510-5 and 510-9 are selected for the new data item 610-2.

Usually, the new data item and the first set of historical data items are multi-dimensioned. In this case, in order to compare the structure of the new data item and the first set of historical data items, these data items can be projected from the multiple dimensions into one single dimension. For example, as described above, each data item may include several fields, and each field can be treated as a dimension, thus each data item may include several dimensions.

In order to project a data item, the computer system/server 12 may determine at least one set of weights, such as [a1, a2, a3, ... , ai], [b1, b2, b3, ... , bi], [c1, c2, c3, ... , ci], or the like, in which i represents the number of dimensions or fields of the data item. In some embodiments, the set of weights can be randomly determined. Alternatively, or in addition, a dimension or field with more importance can be assigned with a higher weight. For example, if the field of gender is more important than other fields, the weight for the field of gender may be higher than the other fields. Moreover, in some embodiments, the set of weights can be normalized, such that the sum of all the weights of the set of weights equals to 1. For example, for the set of weights [a1, a2, a3, ... , ai], the sum of a1, a2, a3, ... , ai is 1.

The data item can be weighted by the set of weights, so as to convert the multi-dimensioned data item into a single dimensioned projecting result. Specifically, the value of each field of the data item can be multiplied by a corresponding weight of the set of weights. The projecting result can be called a target value. The target values of the first set of historical data items can form a target value distribution.

In addition, it can be seen that each set of weights can derive a projecting result. In this case, if there is at least one set of the weights, then the new data item can be projected into at least one target value. Each of the at least one target value corresponds to a respective set of weights of the at least one set of weights. Similarly, with the at least one set of the weights, the first set of historical data items can be projected into at least one target value distribution. Each of the at least one target value distribution corresponds to a respective set of weights of the at least one set of weights.

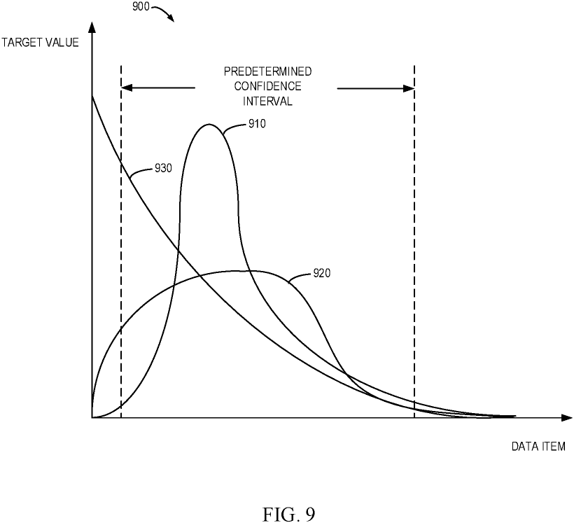

FIG. 9 depicts a schematic diagram 900 of an example of target value distributions according to an embodiment. As shown in FIG. 9, the set of historical data items can be projected into three target value distributions 910-930 with three set of weights, respectively.

Then, the computer system/server 12 may check whether the target value of the new data item is in a predetermined confidence interval (such as, 90% confidence interval or any appropriate confidence interval) of a corresponding target value distribution of the first set of historical data items. It should be understood that, although FIG. 9 shows the same confidence interval for the three target value distributions 910-930, the target value distributions 910-930 may have different confidence intervals.

If the target value is in the predetermined confidence interval, it means that the target value belongs to the target value distribution. For example, it is assumed that a target value of the new data item projected from the set of weights [a1, a2, a3, ... , ai] is in the 90% confidence interval of a corresponding target value distribution of the first set of historical data items projected from the same set of weights [a1, a2, a3, ... , ai], then the target value belongs to the target value distribution. In this case, the new data item has the same structure with the first set of historical data items.

Otherwise, if all of the at least one target value is not in its corresponding target value distribution, it means that the new data item has a different structure with the first set of historical data items. For example, it is assumed that all of the three target values of the new data item projected from three sets of weights [a1, a2, a3, ... , ai], [b1, b2, b3, ... , bi] and [c1, c2, c3, ... , ci] are not in the 90% confidence interval of their respective target value distributions of the first set of historical data items projected from the same sets of weights [a1, a2, a3, ... , ai], [b1, b2, b3, ... , bi] and [c1, c2, c3, ... , ci], the new data item has a different structure from the first set of historical data items. Since the first set of historical data items are the most similar data items for the new data item among all the plurality of historical data items 510, the new data item must have a different structure from all the historical data items 510 if the new data item has a different structure from the first set of historical data items. In this way, the new data item can be determined to be a data item in the third set of new data items.

The determination of the structural difference has been described above, and the following text will further describe the confidence difference.

The confidence difference is associated with the difference between the confidences or predicted values obtained by applying the new data items 610 and the historical data items 510 to the model, respectively. Specifically, the confidence difference is associated with a proportion of new data items having a confidence dissimilar to the historical data items 510 in all the new data items 610. In some embodiments, in order to determine the confidence difference, the computer system/server 12 may select, from all the new data items 610, a set of new data items similar to the historical data items 510. In this case, the outlier new data items will be excluded from the selection.

Specifically, the computer system/server 12 may select a fourth set of new data items from the plurality of new data items. A cluster of each data item in the fourth set of new data items according to the second plurality of clusters is the same as a cluster of the first plurality of clusters. For example, the new data items 610-1, 610-2, 610-3 and 610-M can be selected into the set of the new data items, because their clusters belong to the clusters 1-3 of the historical data items 610. It should be understood that the fourth set of new data items may be the same as the second set of new data items. In this case, the second set of new data items may be directly used as the fourth set of new data items, and the selecting of the fourth set of new data items can be omitted.

Then, the computer system/server 12 may select a fifth set of new data items from the fourth set of new data items. A confidence of each data item in the fifth set of new data items is different from confidences of the plurality of historical data items. In this case, the computer system/server 12 may determine the fourth number of data items in the fifth set of new data items, that is to say, the total number of all the data items in the fifth set of new data items.

As described above, the confidence difference is associated with a proportion of new data items having a confidence dissimilar to the historical data items 510 in all the new data items 610. In this case, the computer system/server 12 may determine the confidence difference based on the first number of items in the plurality of new data items and the fourth number. For example, the confidence difference may be the quotient derived by dividing the fourth number with the first number. In this case, more new data items having confidences different from the confidences of the historical data item 510 will result in a higher confidence difference, which also means that the new data items 610 are more different from the historical data items 510.

In some embodiments, in order to select the fifth set of new data items, the computer system/server 12 may perform the following process for each data item of the fourth set of new data items. For example, the computer system/server 12 may select historical data items of the same cluster as the new data item. Specifically, the computer system/server 12 may determine a cluster of the new data item. Then, the computer system/server 12 may select a second set of historical data items from the plurality of historical data items. The second set of historical data items have been clustered into the cluster.

For example, it is assumed that the new data item 610-2 and the historical data items 510-2, 510-5 and 510-9 are clustered into the cluster 3. In this case, the historical data items 510-2, 510-5 and 510-9 are selected for the new data item 610-2.

Then, the computer system/server 12 may determine a confidence of the new data item and a confidence interval of the second set of historical data items. To determine the confidence of the new data item, the computer system/server 12 may apply the new data item to the model.

In addition, to determine the confidence interval of the second set of historical data items, the computer system/server 12 may apply the second set of historical data items to the model to obtain a set of intermediate confidence intervals. Specifically, for each of the second set of historical data items, the model may output a predetermined intermediate confidence interval (such as 95% confidence interval or any appropriate confidence interval). Each intermediate confidence interval may have a lower bound and an upper bound.

Further, the confidence interval may be determined from the set of intermediate confidence intervals. For example, the set of intermediate confidence intervals may be averaged to obtain the confidence interval. Alternatively, the minimum lower bound of the lower bounds of the set of intermediate confidence intervals may be used as the lower bound of the confidence interval, and the maximum upper bound of the upper bounds of the set of intermediate confidence intervals may be used as the upper bound of the confidence interval.

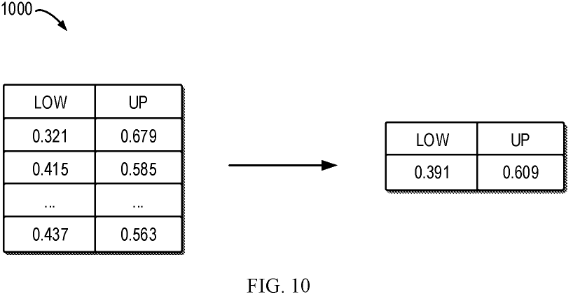

FIG. 10 depicts a schematic diagram 1000 of an example of a confidence interval according to an embodiment. As shown in FIG. 10, the set of intermediate confidence intervals may be averaged to obtain the confidence interval. Specifically, the lower bounds and the upper bounds of the set of intermediate confidence intervals are averaged to obtain the lower bound and upper bound of the confidence interval. If the confidence of the new data item fails to fall within the confidence interval, it means that the new data item has a different confidence with the second set of historical data items. Since the of historical data items are the most similar data items for the new data item, the new data item must have a different confidence from all the historical data items 510 if the new data item has a different confidence from the second set of historical data items.

In addition, in some embodiments, the computer system/server 12 may adjust the model to improve the accuracy of the confidence interval. For example, the regression coefficient of the linear model can be adjusted. In this case, the computer system/server 12 may adjust parameters of the model to obtain at least one adjusted model, and apply the new data item to the at least one adjusted model to determine at least one confidence. Each of the at least one confidence corresponds to a respective adjusted model of the at least one adjusted model.

In addition, the computer system/server 12 may also apply the second set of historical data items to the at least one adjusted model to determine at least one confidence interval. Each of the at least one confidence interval corresponds to a respective adjusted model of the at least one adjusted model.

In this case, if the confidence of the data item fails to fall within the confidence interval of the second set of historical data items, the computer system/server 12 may determine that the data item is a data item in the fifth set of new data items. In addition, in some embodiments, the model is adjusted to obtain at least one adjusted model. In this case, if all the at least one confidence fails to fall within its respective confidence interval of the at least one confidence interval, the computer system/server 12 may determine that the data item is a data item in the fifth set of new data items.

In this way, the overall difference, the structural difference, and/or the confidence difference between the historical data items 510 and the new data items 610 are determined appropriately, such that efficient and accurate model update determination can be achieve based on these differences.

The present embodiments may be a system, a method, and/or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by one or more processors, a plurality of historical data items and a plurality of new data items, the plurality of historical data items being used for training a model, and the plurality of new data items being applied to the model;
determining, by the one or more processors, at least one of an overall difference, a structural difference, and a confidence difference between the plurality of historical data items and the plurality of new data items; and
determining, by the one or more processors, an indication of whether to update the model based on the at least one of the overall difference, the structural difference, and the confidence difference.

2. The method of claim 1, further comprising:
clustering, by the one or more processors, the plurality of historical data items into a first plurality of clusters;
clustering, by the one or more processors, the plurality of new data items into a second plurality of clusters;
determining, by the one or more processors, a first number of data items in the plurality of new data items.

3. The method of claim 2, wherein determining the overall difference comprises:
selecting, by the one or more processors, a first set of new data items from the plurality of new data items, a cluster of each data item in the first set of new data items according to the second plurality of clusters being different from the first plurality of clusters;
determining, by the one or more processors, a second number of data items in the first set of data items; and
determining, by the one or more processors, the overall difference based on the first number and the second number.

4. The method of claim 2, wherein determining the structural difference comprises:
selecting, by the one or more processors, a second set of new data items from the plurality of new data items, a cluster of each data item in the second set of new data items according to the second plurality of clusters being the same as a cluster of the first plurality of clusters;
selecting, by the one or more processors, a third set of new data items from the second set of new data items, a structure of each data item in the third set of new data items being different from structures of the plurality of historical data items;
determining, by the one or more processors, a third number of data items in the third set of new data items; and
determining, by the one or more processors, the structural difference based on the first number and the third number.

5. The method of claim 4, wherein selecting the third set of new data items comprises:
for each data item of the second set of new data items:
determining, by the one or more processors, a cluster of the data item;
selecting, by the one or more processors, a first set of historical data items from the plurality of historical data items, the first set of historical data items having been clustered into the cluster;
determining, by the one or more processors, a target value of the data item and a target value distribution of the first set of historical data items; and
in accordance with a determination that the target value of the data item fails to fall within the target value distribution of the first set of historical data items, determining, by the one or more processors, that the data item is a data item in the third set of new data items.

6. The method of claim 5, wherein determining the target value and the target value distribution comprises:
determining, by the one or more processors, a set of weights;
weighting, by the one or more processors, the data item by the set of weights to determine the target value of the data item; and
weighting, by the one or more processors, the first set of historical data item by the set of weights to determine the target value distribution of the first set of historical data item.

7. The method of claim 2, wherein determining the confidence difference comprises:
selecting, by the one or more processors, a fourth set of new data items from the plurality of new data items, a cluster of each data item in the fourth set of new data items according to the second plurality of clusters being the same as a cluster of the first plurality of clusters;
selecting, by the one or more processors, a fifth set of new data items from the fourth set of new data items, a confidence of each data item in the fifth set of new data items being different from confidences of the plurality of historical data items;
determining, by the one or more processors, a fourth number of data items in the fifth set of new data items; and
determining, by the one or more processors, the confidence difference based on the first number and the fourth number.

8. The method of claim 7, wherein selecting the fifth set of new data items comprises:
for each data item of the fourth set of new data items:
determining, by the one or more processors, a cluster of the data item;
selecting, by the one or more processors, a second set of historical data items from the plurality of historical data items, the second set of historical data items having been clustered into the cluster;
determining, by the one or more processors, a confidence of the data item and a confidence interval of the second set of historical data items;
in accordance with a determination that the confidence of the data item fails to fall within the confidence interval of the second set of historical data items, determining, by the one or more processors, that the data item is a data item in the fifth set of new data items.

9. The method according to claim 8, wherein determining the confidence and the confidence interval comprises:
applying, by the one or more processors, the data item to the model to determine the confidence; and
applying, by the one or more processors, the second set of historical data items to the model to determine the confidence interval.

10. A system, comprising:
one or more computer readable storage media with program instructions collectively stored on the one or more computer readable storage media; and
one or more processors configured to execute the program instructions to perform a method comprising:
obtaining a plurality of historical data items and a plurality of new data items, the plurality of historical data items being used for training a model, and the plurality of new data items being to be applied to the model;
determining at least one of an overall difference, a structural difference, and a confidence difference between the plurality of historical data items and the plurality of new data items; and
determining an indication indicating whether to update the model based on the at least one of the overall difference, the structural difference, and the confidence difference.

11. The system of claim 10, wherein the acts further comprises:
clustering the plurality of historical data items into a first plurality of clusters;
clustering the plurality of new data items into a second plurality of clusters;
determining a first number of data items in the plurality of new data items.

12. The system of claim 11, wherein determining the overall difference comprises:
selecting a first set of new data items from the plurality of new data items, a cluster of each data item in the first set of new data items according to the second plurality of clusters being different from the first plurality of clusters;
determining a second number of data items in the first set of data items; and
determining the overall difference based on the first number and the second number.

13. The system of claim 11, wherein determining the structural difference comprises:
selecting a second set of new data items from the plurality of new data items, a cluster of each data item in the second set of new data items according to the second plurality of clusters being the same as a cluster of the first plurality of clusters;
selecting a third set of new data items from the second set of new data items, a structure of each data item in the third set of new data items being different from structures of the plurality of historical data items;
determining a third number of data items in the third set of new data items; and
determining the structural difference based on the first number and the third number.

14. The system of claim 13, wherein selecting the third set of new data items comprises:
for each data item of the second set of new data items:
determining a cluster of the data item;
selecting a first set of historical data items from the plurality of historical data items, the first set of historical data items having been clustered into the cluster;
determining a target value of the data item and a target value distribution of the first set of historical data items; and
in accordance with a determination that the target value of the data item fails to fall within the target value distribution of the first set of historical data items, determining that the data item is a data item in the third set of new data items.

15. The system of claim 14, wherein determining the target value and the target value distribution comprises:
determining a set of weights;
weighting the data item by the set of weights to determine the target value of the data item; and
weighting the first set of historical data item by the set of weights to determine the target value distribution of the first set of historical data item.

16. The system of claim 11, wherein determining the confidence difference comprises:
selecting a fourth set of new data items from the plurality of new data items, a cluster of each data item in the fourth set of new data items according to the second plurality of clusters being the same as a cluster of the first plurality of clusters;
selecting a fifth set of new data items from the fourth set of new data items, a confidence of each data item in the fifth set of new data items being different from confidences of the plurality of historical data items;
determining a fourth number of data items in the fifth set of new data items; and
determining the confidence difference based on the first number and the fourth number.

17. The system of claim 16, wherein selecting the fifth set of new data items comprises:
for each data item of the fourth set of new data items:
determining a cluster of the data item;
selecting a second set of historical data items from the plurality of historical data items, the second set of historical data items having been clustered into the cluster;
determining a confidence of the data item and a confidence interval of the second set of historical data items;
in accordance with a determination that the confidence of the data item fails to fall within the confidence interval of the second set of historical data items, determining that the data item is a data item in the fifth set of new data items.

18. The system according to claim 17, wherein determining the confidence and the confidence interval comprises:
applying the data item to the model to determine the confidence; and
applying the second set of historical data items to the model to determine the confidence interval.

19. A computer program product comprising:
one or more computer readable storage media, and program instructions collectively stored on the one or more computer readable storage media, the program instructions executable by one or more processors to cause the one or more processors to perform actions comprising:
obtaining a plurality of historical data items and a plurality of new data items, the plurality of historical data items being used for training a model, and the plurality of new data items being to be applied to the model;
determining at least one of an overall difference, a structural difference, and a confidence difference between the plurality of historical data items and the plurality of new data items; and
determining an indication indicating whether to update the model based on the at least one of the overall difference, the structural difference, and the confidence difference.

20. The computer program product of claim 19, further comprising:
clustering the plurality of historical data items into a first plurality of clusters;
clustering the plurality of new data items into a second plurality of clusters;
determining the first number of data items in the plurality of new data items.
